(19) United States
(12) Patent Application Publication
(10) Pub. No.: US 2025/0173935 A1
(43) Pub. Date: May 29, 2025

(54) DEVICE FOR SYNCHRONIZATION OF FEATURES OF DIGITAL OBJECTS WITH AUDIO CONTENTS

(71) Applicant: NEURALGARAGE PRIVATE LIMITED, Maharashtra (IN)

(72) Inventors: Anjan BANERJEE, West Bengal (IN); Subhashish SAHA, West Bengal (IN); Subhabrata DEBNATH, Kolkata (IN)

(21) Appl. No.: 18/724,545

(22) PCT Filed: Dec. 29, 2022
(86) PCT No.: PCT/IN2022/051142

§ 371 Date: Jun. 26, 2024

(30) Foreign Application Priority Data
Dec. 29, 2021 (IN) 202121061424

(51) Int. Cl. G06T 13/20; G06T 13/40; G11B 27/10

(52) U.S. Cl. CPC G06T 13/205; G06T 13/40; G11B 27/10

(57) ABSTRACT

Disclosed is a device for synchronization of features of digital objects with audio contents (100). The device of the present invention synchronizes the features of digital objects and audio contents of the audio-visual environment. The device (100) includes a processing unit (105), an input unit (110), and an output unit (115). The device (100) is removably connectable to a host device (120) and a power supply unit (125). The processing unit (105) is defined by a microcontroller and it is configured with various modules that are responsible for synchronization of features of digital objects with audio contents. The device of the present invention advantageously transforms the feature of the digital object in the input video to be in synchronization with audio content irrespective of the identity of object and language of audio.

### FIELD OF THE INVENTION

The present invention relates to systems for lip synchronization in audiovisual environment, and more particularly to a device for synchronization of lip movements of a dynamic object displayed on a digital device with one or more predefined audio contents generating a realistic lip movement of the object according to the contents of the audios.

### BACKGROUND OF THE INVENTION

With the constant evolution of the entertainment industry and the rise in the number of consumers for the media, there is an increased demand in the creation of audio-video content. With the advent of science and various technological tools, creation, and dissemination of content to most of the audience has become easy.

Now-a-days, there is an increased demand from the consumers for audio-visual content which is easy to assimilate and understand. Today, the media created in one part of the world is easily accessible in another remote part of the world due to internet connectivity and social media network. Due to the global accessibility and acceptability of the media content, it has surpassed cultural boundaries and has become the driving force of the global economy.

One of the major factors that affects the content creation which appeals to the global consumer is the language barrier. The content and media created in one language is not easily discernible to the public at large if the language of the content and video is incomprehensible. To overcome these barriers, technological research is being done in the field of audio to visual synchronization of the content.

The video content is dubbed, or the language of the video is translated for improved comprehensibility of the consumer. But in this case, the video seems out of sync with the dubbed/translated audio content which reduces the overall consumer experience and output effect of the content created. Technological advancement has led to the generation of realistic video by synchronization of video or images with translated or dubbed audio. The field of application of this technology is vast ranging from audio visual synchronization of online lecture series, movies, public address, or speeches.

There are several attempts in existing art for neural voice puppetry that work well with high quality automated re-dubbing. However, these techniques are trained specific to speakers. These techniques are not identity agnostic and do not scale well for general cases. Additional audio-visual data is required for pre-processing per identity. Conventional approaches are not able to automatically generate expressive lip-synchronized facial animation that is not only based on certain unique phonetic shapes, but also based on other visual characteristics of a person's face during speech.

The US Patent No. U.S. Pat. No. 7,133,535B2 to Ying Huang et al. teaches a computer-implemented method for synchronizing the lips of a sketched face to an input voice. This method is based on training the video on Hidden Markov Models. However, this method fails to provide synchronization of the audio content with the visual content with an improved level of accuracy of the synchronization.

The US Patent U.S. Pat. No. 10,755,463B1 to Elif Albuz et al. discloses audio-driven facial tracking and animation. The method is used for animation of the lips, eyebrows, eyelids, and other portions of the upper face. The existing technologies in the field of audio-visual synchronization of lip and facial movements with the inputted audio are based on deep learning technologies in which a video is trained on artificial neural networks to obtain better resolution of the image synchronized with the audio content. However, during the training of the video, the original quality of the facial shapes is not preserved, and the quality of image gets distorted.

Similarly, few more attempts providing speaker independent solutions for lip synchronization based on generative adversarial network (GAN) have been reported in the prior art. Although, these models are not speaker specific but while generating lip movements, they often generate artefacts, obviously that are not acceptable for professional use. Moreover, these models are trained usually at lower resolution. Therefore, these models usually are not able to match the quality of generations at the higher resolutions.

It is observed that the several attempts reported in the prior art generate lip poses directly from the audio signal. However, these techniques are limited to predicting vowel shapes and ignore temporal effects such as co-articulation. These methods fail to address the actual dynamics of the face.

Accordingly, there is a need for a device for synchronization of features of digital objects with predefined audio contents that creates realistic movements of the features of the objects in audiovisual environment.

### SUMMARY OF THE INVENTION

The present invention discloses a device for synchronization of features of digital objects with audio contents. The device for synchronization of the present invention includes a processing unit, an input unit, and an output unit. The device is removably connectable to a host device and a power supply unit.

The processing unit is configured to receive input data from the input unit and to send the output data to the output unit. The processing unit includes a communication unit, a control unit, and a storage unit for processing the input data and generating the output.

The control unit includes a processing module, an encoding unit, and a feature master. The control unit also includes a generator, a transformation module, an estimator unit, a discriminator unit, and a stabilizer. The processing module is configured on the control unit for extracting the audio segments from the input data.

The encoding unit is configured on the control unit for separating audio segments and inputs into various framesets and embedding into various features sets. The encoding unit is configured with a first encoder, a second encoder and a third encoder. The first encoder is a three dimensional (3D) pose encoder, the second encoder is an expression encoder, the third encoder is a lip movement encoder, the fourth encoder is an audio encoder, and the fifth encoder is an identity encoder.

The feature master is configured on the control unit for concatenating difference feature vectors and feature set. The generator is configured on the control unit for decoding the latent vectors learned from the encoding unit and generating objects that are synced with audio. The transformation module is configured on the control unit for aligning target frames with the predefined shape of a set of synced predicted frames.

The discriminator unit is configured on the control unit for penalizing inaccurate generation for each resolution. The discriminator unit is configured with a first discriminator, a second discriminator, and third discriminator. The first discriminator is a landmark based discriminator, the second discriminator is a multiscale perceptual discriminator, and the third discriminator is an audio-visual alignment discriminator.

The estimator unit is configured on the control unit for computing displacement between the input objects and the generated objects. The estimator unit is configured with a first estimator, a second estimator, and a third estimator, and a fourth estimator. The first estimator is configured to predict the shape of the features for each of the synced predicted frames. The second estimator is configured to predict the naturalness of movement and change in shape of the features for each of the synced predicted frames. The third estimator predicts the segments of the features for each of the synced predicted frames. The fourth estimator is connected to the stabilizer for stabilizing the video frames. The stabilizer is configured on the control unit for stabilizing the frames and sends transformed frameset to the output unit.

### BRIEF DESCRIPTION OF DRAWINGS

The objectives and advantages of the present invention will become apparent from the following description read in accordance with the accompanying drawings wherein,

FIG. 1 shows a schematic of a device for synchronization of features of digital objects with audio contents in accordance with the present invention;

FIG. 2 shows a schematic of a control unit of the device of the FIG. 1;

FIG. 3 shows a schematic of an encoding unit of the device of the FIG. 1;

FIG. 4 shows a schematic of a generator and a discriminator unit of the device of the FIG. 1;

FIG. 5 shows a schematic of an estimator unit and a transformation module of the device of the FIG. 1; and

FIG. 6 shows various steps involved in operation of the of the device of the FIG. 1.

### DETAILED DESCRIPTION OF THE DRAWINGS

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed and obviously many modifications and variations are possible in light of the above teaching.

In general aspect, the present invention is a device for synchronization of features of digital objects with audio contents in audio visual environment irrespective of the audio language of the original content, identity of the speaker and the language of the dubbed speech. The device of the present invention creates realistic lip movements in audio-visual content.

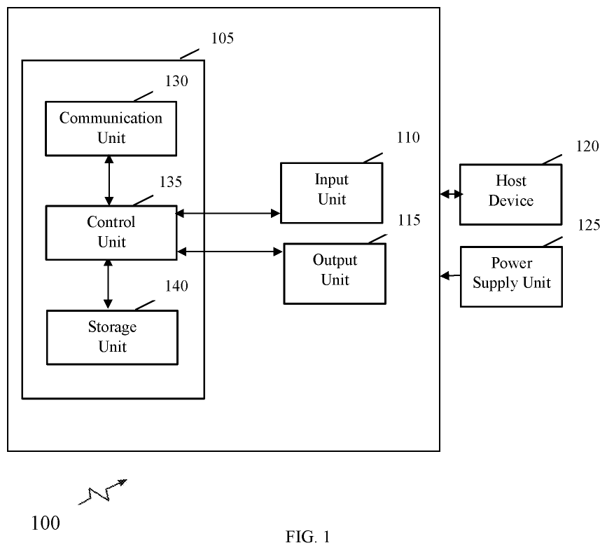

Referring to FIG. 1, a device for synchronization of features of digital objects with audio contents 100 (hereinafter referred to as “device 100”) in accordance with a preferred embodiment of the present invention is described. The device 100 includes a processing unit 105, an input unit 110, and an output unit 115. The device 100 is removably connectable to a host device 120 and a power supply unit 125.

The processing unit 105 has a first port that is connected with the input unit 110 and a second port that is connected to the output unit 115. The processing unit 105 includes by a microcontroller i.e. configured to receive the input data from the input unit 110. Further, the processing unit 105 is configured to process the data, to generate the results, and to send the output data to the output unit 115. The power supply unit 104 supplies power required to the device 100.

The device 100 further includes a connector, a switch, a LED, and a casing. The connector defines an external portion of the device 100 that is connectable to a host device 120. A set of wires and cables connect the device 100, the host device 120, and the power supply unit 125 with each other. However, in another embodiment, the device 100 and host device 120 are connectable by wireless media such as Wi-Fi, blue tooth etc. The switch advantageously enables and disables secured recording or writing of data in the device 100. The casing preferably defines a hard-outer shell of the device 100 and preferably protects various delicate components of the device 100. A plurality of LEDs positioned at predefined locations are lighted components that indicate predefined stages of operation of the device 100, for example, processing, connection, etc. to one or more users of the device 100. The memory chip stores data that is pre-configured or pre-recorded or any newly generated data during the operation of the device 100.

The processing unit 105 includes a communication unit 130, a control unit 135 and a storage unit 140. The control unit 135 also includes the microcontroller that selectively controls access of host device 120 to the device 100. The microcontroller is advantageously configured on the processing unit 105 of the device 100 to receive input data from the input unit 110, to process the input data, and to generate new data in accordance with the present invention. The processing unit 105 advantageously controls access of the device 100 by external system such as the host system, thereby enabling synchronization of various features of the digital objects with one or more audio contents.

For example, a cartoon character is a digital object that is displayable on an output device of a digital device like a computer, tab, mobile phone etc. Now lips, eyebrows, cheeks, ears, jaws etc. include features of the digital object of the cartoon in accordance with the present invention. A digital object may be a human face, an animal face or an imaginary character that is part of visual content like a pre-recorded video in a format like .mp4 for example. The features of the digital objects, digital character or any object that is convertible to a digital object/s etc. are synchronized with a plurality of prerecorded audio files in. for example, mp3 or wav format. The control unit 135 is configured for synchronization of features of the digital objects and audio contents of the audio-visual environment in accordance with the present invention.

The storage unit 140 retrieves manage the data of the device 100. The storage unit 140 stores and retrieves the cached data of the device 100 and manages data transaction with the local persistent storage. The communication unit 130 (Ref. FIG. 1) is the internet or some other wired and/or wireless data network, including, but not limited to, any suitable wide area network or local area network.

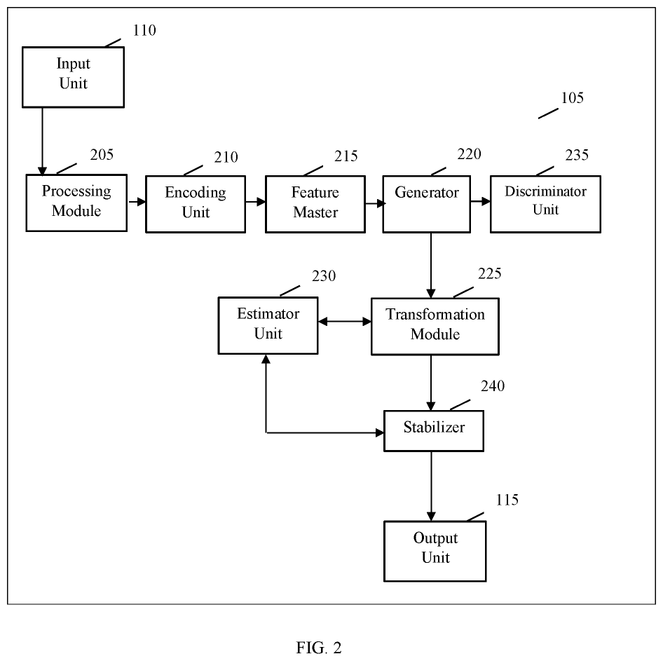

Now referring to FIG. 2, a schematic of the control unit 135 of the device 100 in accordance with the present invention is now described. In this one embodiment, the control unit 135 includes a processing module 205, an encoding unit 210, and a feature master 215. The control unit 135 also includes a generator 220, a transformation module 225, an estimator unit 230, a discriminator unit 235, and a stabilizer 240.

The processing module 205 receives the input data from the input unit 110. The processing module 205 extracts the audio features from the input data. In accordance with the present invention, from each of the input audiovisual contents or video contents, digital objects are extracted from each frame of the video and resized to predefined scale. The encoding unit 210 separates the audio features and digital objects from the input audiovisual contents into various framesets. These separated audio features and extracted digital objects are embedded into various features sets by the encoding unit 210. The feature master 215 is configured for concatenating difference feature vectors and feature sets embedded by the encoding unit 210.

The generator 220 defines a decoder of the present invention. The generator 220 decodes all the latent vectors received from the encoding unit 210 and generates objects with the features that are synced with audio contents in accordance with the present invention. The estimator unit 230 computes displacement between the features of input objects and the features of generated objects. The specific regions of the features of input objects are transformed by the transformation module 225 using the calculated displacement. The discriminator unit 235 penalizes inaccurate generation for each resolution by determining a score by comparing a set of aligned target frames 305 and synced predicted frames 240. The stabilizer 240 the stabilizes the frames and sends transformed frameset to the output unit 115.

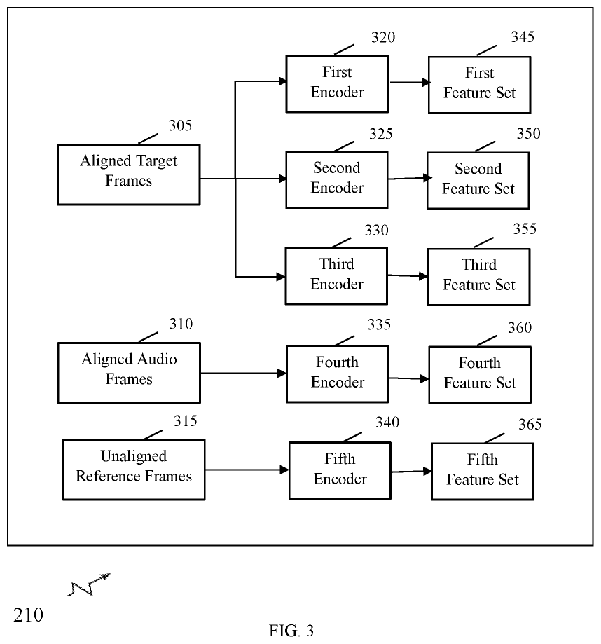

Referring to FIG. 3, a schematic of the encoding unit 210 of the device 100 is described. The encoding unit 210 processes the data stored in an aligned target frames 305, an aligned audio frames 310, and an unaligned reference frames 315.

The aligned target frames 305 includes a set of predefined features of the target digital object that are aligned with predefined audio segment i.e. the audio content received from the input unit 110. The processing unit 105 separates the video frames from the video received from the input unit 110 and aligns the separated video frames with the audio content received from the input unit 110 to define aligned target frames 305. The aligned audio frames 310 include the aligned audio segments. The aligned audio segment are the extracted audio segments from the audio content received from the input unit 110. For example, for a video clip ‘A’ including digital objects and for an audio content ‘B’ received from the input unit 110, the aligned target frames 305 includes the visual frames from the video clip ‘A’ aligned with audio segments from the audio content ‘B’ and the aligned audio frames 310 includes the extracted audio segments from the audio content ‘B’.

The unaligned reference frames 315 includes random features extracted from the digital objects. It is noted that the processing module separates the random features of the digital objects that are not aligned with the audio. The random features extracted from the digital objects are stored in the unaligned reference frames 315. The unaligned reference frames 315 are used to learn identity features. It is noted that identity features mean the identification references computed for the digital object. For example, the similar shapes or features of specific object determines the identity of that particular digital object, e.g., face of specific human, face of the specific cartoon character are extracted as identity features.

In accordance with the present invention, the aligned target frames 305 and aligned audio frames 310 are provided as input data to predefined encoders. Accordingly, the aligned target frames 305 are received by a first encoder 320, a second encoder 325 and a third encoder 330 as the input data. The aligned audio frames 310 are fed to a fourth encoder 335 and the unaligned reference frames 315 are received by a fifth encoder 340. Each encoder is configured to process the respective data received and to generate respective feature set.

The first encoder 320 is configured to estimate the shape of the features of the object/s and its appearance. The first encoder 320 implements pixel wise depth mapping, and 3D mesh modelling to estimate and map the shape of the features of objects and the appearance of the object. It is, however, noted that the pixel wise depth map is a self-supervised geometry learning method employed to estimate the 3D object structure from video contents and 3D mesh modelling method to estimate shape of feature and motion of the attributes in the video frame.

The second encoder 325 is configured to estimate expression parameters from the upper half region of the object. The third encoder 330 is configured with to estimating and map movements of feature of objects from the lower half of said target object. The fourth encoder 335 is configured to estimate and map latent parameters of the input audio sequence. The fourth encoder 335 includes a plurality of residual blocks that estimates a set of latent parameters from input audio sequence. The fifth encoder 340 is configured to extract identity features from the object. The fifth encoder 340 is a residual convolution neural network based encoder that extracts identity features from the extracted digital objects The fifth encoder 340 is trained for capturing identity information from the unaligned reference frames 315. In the preferred embodiment of the present invention, the first encoder 320 is preferably a three dimensional (3D) pose encoder, the second encoder 325 is an expression encoder, the third encoder 330 is a lip movement encoder, the fourth encoder 335 is an audio encoder, and the fifth encoder 340 is an identity encoder.

Further, in the preferred embodiment of the present invention, a first feature set 345 is a datastore of extracted pose features, a second feature set 350 is a datastore of extracted expression features, and a third feature set 355 is a datastore of extracted facial features. Further, a fourth feature set 360 is a datastore of extracted audio features, and a fifth feature set 365 is a datastore of extracted identity features in the preferred embodiment.

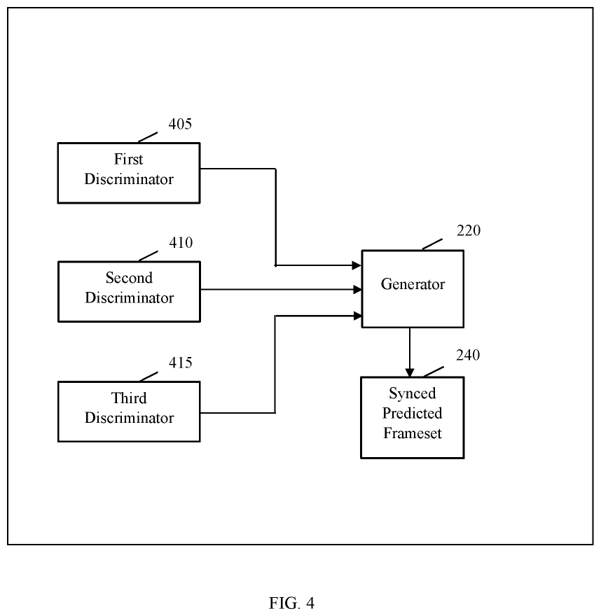

Referring to FIG. 4, a schematic diagram shows connectivity of the generator 220 and the discriminator unit 235 of the device 100. The synced predicted frameset 240 is a set of predicted frames for shape of the feature for each of the aligned target frames 305. The generator 220 decodes all the latent vectors that are received from the encoding unit 210 to generate objects that are synced with audio. The encoding unit 210 is learned to estimate various parameters of the digital object. For example, parameters such as identity, pose, shape, expression, and lighting. The synced objects are advantageously stored in the synced predicted frameset 240.

The discriminator unit 235 includes with plurality of discriminators, namely a first discriminator 405, a second discriminator 410, and third discriminator 415. The first discriminator 405 is configured to determine a score of by comparing the aligned target frames 305 and synced predicted frames 240. The first discriminator 405 computes a score that denotes whether the predefined landmarks correspond to the specific audio. The first discriminator 405 recognises the score that is required by the generator 220 to generate frames including the structures that have landmarks in alignment with the audio content i.e., audio.

The second discriminator 410 computes a score that denotes how different is the synced generated frames from the aligned target frames 305 perceptually at various scales. The second discriminator 410 provides this score to the generator 220 to generate frames including the structures that look perceptually like the original aligned target frames 305. The second discriminator 410 is configured to maintain the visual quality component.

The third discriminator 415 computes a score that denotes whether the specific region corresponds to the audio. The third discriminator 415 provides this score to the generator 220 to generate frames including the structures that to generate frames having matching object regions aligned with the audio.

In preferred embodiment of the present invention, the first discriminator 405 is landmark based discriminator, the second discriminator 410 is multiscale perceptual discriminator, and the third discriminator 415 is audio-visual alignment discriminator.

In accordance with the present invention, the encoder unit 210 is a residual convolution neural network that is trained on predefined audio-visual dataset. The encoder unit 210 is learned capture the parameters of the digital object. For example, parameters like identity, pose, shape, expression, and lighting. The estimator unit 230 is trained on predefined audio-visual dataset. The discriminator unit 235 is learned to recognise the relationship between audio segments and features of digital object.

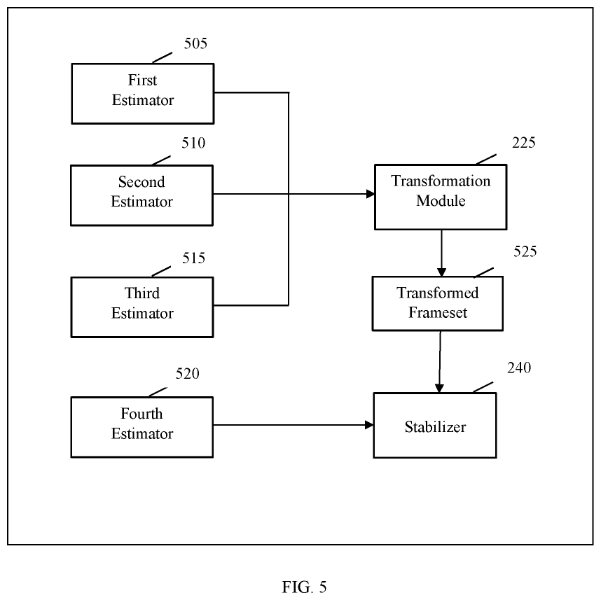

Now referring to FIG. 5, a schematic shows connectivity of the estimator unit 230 and the transformation module 225 of the device 100 is discussed. The transformation module 225 aligns target frames with the predefined shape of the synced predicted frames 240.

The estimator unit 230 is includes a plurality of estimators, namely a first estimator 505, a second estimator 510, and a third estimator 515, and a fourth estimator 520. The first estimator 505 predicts the shape of the features for each of the synced predicted frames 240 that are generated by the generator 220. The first estimator 505 predicts the shape of the features for each of the aligned target frames. The difference between aligned target frames 305 and synced predicted frames 240 is used to guide the transformation module 225 to transform the aligned target frames 305 such that it has lip and jaw structure similar to the synced predicted frames 240.

The second estimator 510 predicts the naturalness of movement and change in shape of the features for each of the consecutive synced predicted frames 240 which are generated by the generator 220. The second estimator 510 also predicts the naturalness of movement and change in shape of the features for each of the aligned target frames 305. The difference in between aligned target frames 305 and synced predicted frames 240 is used to guide the transformation module 225 to regenerate the aligned target frames 305 such that it has the change in feature (velocity) similar to that of the synced predicted frames 240 and parameters such as pose, quality, identity etc. similar to that of the aligned target frames 305.

The third estimator 515 predicts the segments of the features for each of the synced predicted frames 240 that are generated by the generator 220. The third estimator 515 predicts the segments of the features for each of the aligned target frames 305. The difference between aligned target frames 305 and synced predicted frames 240 is used to guide the transformation module 225 to transform the aligned target frames 305 such that it has feature segments similar to the synced predicted frames 240. The fourth estimator 520 is connected to the stabilizer 240 and configured with functionality if stabilizing the video frames.

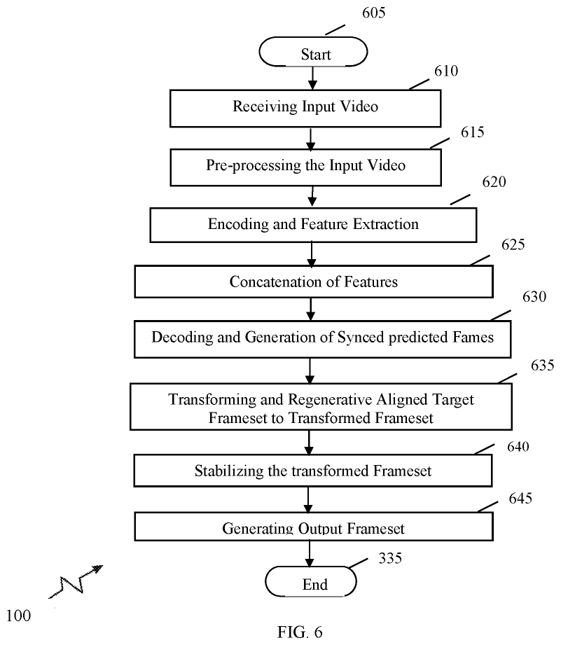

Referring to FIG. 6, a flowchart including various steps involved in the operation of the of the device 100 of the present invention is described.

In a first step 605, the device 100 is initialized. In a next step 610, the input data is received from the input unit 110. In a next step 615, pre-processing of the input video is carried out by the processing module 205. The processing module 205 extracts the audio features from the input data. From each input audio video content, digital objects are extracted from each frame of the video and resized to predefined scale.

In a step 620, encoding and feature extraction is performed by the encoding unit 210. The audio features and visual objects are separated into various framesets and embedded into various features sets. In a step 625, concatenation of extracted features is performed by the encoding unit 210. In this step, the encoding unit 210 concatenates difference feature vectors and feature set.

In next a step 630, decoding and generation of synced predicted frames 240 is carried out. In this step, the generator 220 decodes all the latent vectors received from the encoding unit 210 and generates objects with the features that are synced with audio contents. In step 635, the aligned target frameset 305 is transformed to the transformed frameset. In this step, the transformation module 225 aligns target frames with the predefined shape of the synced predicted frames 240. In a next step 640, the transformed frameset is stabilized. In a step 645, the output frameset is generated. In a step 650, the process is terminated for that instance.

Now referring to FIGS. 1 and 6 in operation, the device 100 is connected to a host device 120. The user inputs a video of a digital object and a corresponding audio that is to be synchronized. The device 100 transform features of the digital objects with the plurality of prerecorded audio files irrespective of the identity of the digital objects and the language of the audio. The device 100 generates high-quality synced output for the given input audio-video content.

Now, the operation of the device 100 is described by considering the lips as a feature of digital object. The device 100 detects faces as digital objects from the input video and extract the audio features from an input audio. The audio feature and face inputs are embedded into intermediate representations by encoding unit. The generator produces a feature synchronized object from the joint audio-visual embedding by inpainting the masked region of the input image with an appropriate feature. For example, the generator produces, a lip-synchronized face from the joint audio-visual embedding by inpainting the masked region of the input image with an appropriate mouth shape. The generator generates lip structures that are used to transform lip regions of any face to match any audio input.

Once the encoders learn to generate lip shapes using information from the audio at a particular resolution, a plurality of discriminators is used to ensure the quality of lips shapes and the quality of synchronization. This information is then used by the model to learn the lip shapes of the next higher resolution where again its visual and synchronization quality is ensured by the plurality of discriminators. This process is carried out progressively until quality and synchronization at the desired resolution is achieved. Here, the phoneme-to-viseme mapping approach is used to achieve lip-sync in any language. The present invention employs a two-stage process, including generation of a robust base representation in sync with the voice input, and using it to transform the lips of the source image to a high-quality lip-synced output.

The device of the present invention advantageously transforms the feature of the digital object in the input video to be in sync with the speech of the input audio irrespective of the identity of object and the language of the audio. The device of the present invention advantageously provides high-quality synchronized output for given audio/video content.

The device of the present invention works for both audio language and face identity agnostic and even works on animated and synthetically generated faces. The device of the present invention advantageously helps to transform existing data to obtain the synchronization of lips in a two-stage procedure by which the artefacts are minimized.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A device for synchronization of features of digital objects with audio contents 100 comprising:
a processing unit 105, the processing unit 105 being configured to receive input data from an input unit 110 and to send the output data an output unit 115, the processing unit 105 including a communication unit 130, a control unit 135, and a storage unit 140 for processing the input data and generating the output;
a processing module 205, the processing module 205 being configured on the control unit 135 for extracting the audio segments from the input data;
an encoding unit 210, the encoding unit 210 being configured on the control unit 135 for separating audio segments and inputs into various framesets and embedding into various features sets;
a feature master 215, the feature master 215 being configured on the control unit 135 for concatenating difference feature vectors and feature sets;
a generator 220, the generator 220 being configured on the control unit 135 for decoding the latent vectors learned from the encoding unit 210 and generating objects that are synced with the audio;
a transformation module 225, the transformation module 225 being configured on the control unit 135 for aligning target frames with the predefined shape of features as generated in synced predicted frames 240;
an estimator unit 230, the encoding unit 210 estimator unit 230 being configured on the control unit 135 for computing displacement between the input objects and the generated objects;
a discriminator unit 235, the discriminator unit 235 being configured on the control unit 135 for penalizing inaccurate generation for each resolution; and
a stabilizer 240, the stabilizer 240 being configured on the control unit 135 for stabilizing the frames and sends transformed frameset to the output unit 115.

2. The device for synchronization of features of digital objects with audio contents 100 as claimed in claim 1, wherein the encoding unit 210 being configured with a first encoder 320, a second encoder 325 and a third encoder 330.

3. The device for synchronization of features of digital objects with audio contents 100 as claimed in claim 1, wherein the first encoder 320 is a three dimensional (3D) pose encoder, the second encoder 325 is an expression encoder, the third encoder 330 is a lip movement encoder, the fourth encoder 335 is an audio encoder, and the fifth encoder 340 is an identity encoder.

4. The device for synchronization of features of digital objects with audio contents 100 as claimed in claim 1, wherein the discriminator unit 235 being configured with a first discriminator 405, a second discriminator 410, and third discriminator 415.

5. The device for synchronization of features of digital objects with audio contents 100 as claimed in claim 1, wherein the first discriminator 405 is a landmark based discriminator, the second discriminator 410 is a multiscale perceptual discriminator, and the third discriminator 415 is an audio-visual alignment discriminator.

6. The device for synchronization of features of digital objects with audio contents 100 as claimed in claim 1, wherein the estimator unit 230 being configured with a first estimator 505, a second estimator 510, and a third estimator 515, and a fourth estimator 520.

7. The device for synchronization of features of digital objects with audio contents 100 as claimed in claim 1, wherein the first estimator 505 being configured to predict the shape of the features for each of the synced predicted frames 240.

8. The device for synchronization of features of digital objects with audio contents 100 as claimed in claim 1, wherein the second estimator 510 being configured to predict the naturalness of movement and change in shape of the features for each of the synced predicted frames 240.

9. The device for synchronization of features of digital objects with audio contents 100 as claimed in claim 1, wherein the third estimator 515 predicts the segments of the features for each of the synced predicted frames 240.

10. The device for synchronization of features of digital objects with audio contents 100 as claimed in claim 1, wherein the fourth estimator 520 being connected to the stabilizer 240 for stabilizing the video frames.
